(19) United States
(12) Patent Application Publication
(10) Pub. No.: US 2015/0234872 A1
(43) Pub. Date: Aug. 20, 2015

(54) COMPUTER, DATA PROCESSING METHOD, AND NON-TRANSITORY STORAGE MEDIUM

(71) Applicant: Hitachi, Ltd., Tokyo (JP)

(72) Inventors: Michio Iijima, Tokyo (JP); Natsuko Sugaya, Tokyo (JP)

(73) Assignee: HITACHI, LTD., Tokyo (JP)

(21) Appl. No.: 14/428,208

(22) PCT Filed: Apr. 12, 2013
(86) PCT No.: PCT/JP2013/061027

§ 371 Date: Mar. 13, 2015

(51) Int. Cl. G06F 17/30; H04L 12/58

(52) U.S. Cl. CPC G06F 17/30321; H04L 51/04; G06F 17/30554

(57) ABSTRACT

A data collection storage area includes messages created as information on at least one theme, each of the messages not indicating that the message is about one of the at least one theme. A computer includes: a unit creation module reorganizing the messages stored in the data collection storage area into at least one data unit including at least one of the messages to indicate that each of the at least one data unit is about one of the at least one theme; an index creation module creating an index from the messages included in the at least one reorganized data unit; a search execution module identifying a data unit matching a search condition based on the created index and the search condition upon receipt of the search condition to search the messages; and a result output module outputting a search result based on the identified data unit.

### BACKGROUND

This invention relates to a computer.

The technology of transmitting e-mails between computers has developed with spread of computers connected to networks. Information to be written as letters is sent from a user to another by e-mail. In addition, searching the transmitted e-mails with full-text search has become more common.

In the meanwhile, the recent prevalence of mobile terminals has increased the use of short messaging services (SMS). The messages sent by an SMS have limitation in the number of characters to be transmitted. Accordingly, a user sends a message consisting of a short sentence to another user.

Recently emerging social networking services (SNS) and free call sendees are implemented by messenger software. The messenger software does not employ the techniques of e-mail but employs techniques of the SMS that transmit short sentences and small amount of information to transmit information between users.

According to the techniques of the SMS, a message for making an inquiry to another user and a message for answering the inquiry are independent from each other; these messages are stored as separate pieces of data. Accordingly, the start and the end of information on a single theme are not included in one message; fragments of the information on the single theme are included in separate messages.

Since fragments of information on a single theme are included in separate messages, when a user wants to retrieve specific information from the information on the single theme, a search technique that determines whether the messages match search conditions one by one might not be able to provide the user with appropriate search results. This problem occurs because, unlike the traditional e-mail technique, the technique of the SMS includes each short sentence spoken in a conversation in a different message to be transmitted.

In using an SMS, a user reads the transmitted messages in order of receipt time and accumulates the acquired data in the user's brain to create information along a story. However, when the user is provided with a piece of data, extracted by a computer after a while of transmission of a series of data, the user cannot obtain desired information unless the user refers to some pieces of data that are created and transmitted before and after the extracted data and are relevant to the extracted data.

Accordingly, techniques have been developed to combine a plurality of messages by some unit and to provide the user with the combined messages as a search result.

To create a unit of a message group, there exists a technique to utilize bibliographic information (for example, refer to JP 2003-178075 A), JP 2003-178075 A discloses: At Step S2, the document property processing unit 22 extracts property information (header information such as message IDs) from the e-mail documents acquired and supplied by the document acquisition unit 21 at Step S1, groups the documents depending on the property information (that is to say, groups the documents by topic), and supplies them to the document content processing unit 23 and the document characteristic database creation unit 24.

### SUMMARY

In the case where fragments of information on one theme are included in separate messages, a computer cannot handle the correlative messages as a single group of data. Accordingly, in searching messages by using a traditional full-text search technique, the computer cannot extract appropriate messages matching search conditions to output meaningful information for the user.

Although techniques have been developed that combine a plurality of messages by some unit to provide the combined messages as a search result, a group of messages created depending on the bibliographic information such as a sender like a group of messages created by the technique disclosed in JP 2003-178075 A may include a noise (data having information that does not match the search conditions). This is because one sender may send messages on different topics and a group created in accordance with bibliographic information may have different themes.

An object of this invention is to provide a method of combining data appropriately to output a search result meaningful for the user.

A representative example of the invention is a computer comprising; a processor; and a memory for storing a program to be executed by the processor, the memory including a data collection storage area, the data collection storage area including a plurality of messages created as information on at least one theme, each of the plurality of messages not indicating that the message is about one of the at least one theme, wherein the computer is configured to include: a unit creation module for reorganizing the plurality of messages stored in the data collection storage area into at least one data unit including at least, one of the plurality of messages to indicate that each of the at least one data unit is about one of the at least one theme; an index creation module for creating an index from the plurality of messages included in the at least one reorganized data unit; a search execution module for Identifying a data unit, matching a search, condition based on the created index and the search condition upon receipt of the search condition to search the plurality of messages; and a result output module for outputting a search result based on the identified data unit.

An embodiment of this invention accomplishes outputting a search result meaningful for the user by combining a plurality of messages into a search unit.

Objects, configuration, and effects of this invention other than those described above are clarified in the following description of embodiments.

### BRIEF DESCRIPTION OF THE DRAWINGS

FIG. 1 is a block diagram illustrating a physical configuration and a logical configuration of a computer system in an embodiment;

FIG. 2A is an explanatory diagram illustrating an example of a message transmitted by e-mail in the embodiment;

FIG. 2B is an explanatory diagram illustrating a plurality of messages on one theme in the embodiment;

FIG. 3A is an explanatory diagram illustrating messages exchanged by a plurality of users in the embodiment;

FIG. 3B is an explanatory diagram illustrating messages exchanged between two users in the embodiment;

FIG. 4 is an explanatory diagram illustrating a data collection in the embodiment;

FIG. 5 is a flowchart illustrating processing of creating search units in this embodiment;

FIG. 6 is an explanatory diagram illustrating examples of index creation information in the embodiment;

FIG. 7 is an explanatory diagram illustrating a bibliographic information table in the embodiment;

FIG. 8 is an explanatory diagram illustrating an extracted data table In the embodiment;

FIG. 9 is an explanatory diagram illustrating a search unit table in the embodiment;

FIG. 10 is an explanatory diagram illustrating a search unit index in the embodiment;

FIG. 11 is an explanatory diagram illustrating a concept of joining search units in the embodiment;

FIG. 12 is a flowchart illustrating search processing on a search unit basis in the embodiment;

FIG. 13A is an explanatory diagram illustrating an example of a screen for inputting a search condition to be displayed on a search client in the embodiment;

FIG. 13B is an explanatory diagram illustrating an example of a screen for outputting a search result to be displayed on a search client in the embodiment;

FIG. 14 is an explanatory diagram illustrating an example of a screen to specify index settings in the embodiment; and

FIG. 15 is an explanatory diagram illustrating index settings in the embodiment.

### DETAILED DESCRIPTION OF THE EMBODIMENTS

Hereinafter, an embodiment of this invention is described in detail with reference to the drawings. A computer in this embodiment reorganizes a plurality of pieces of data each including a fragment of information into a group of data (search unit) having a desired meaning.

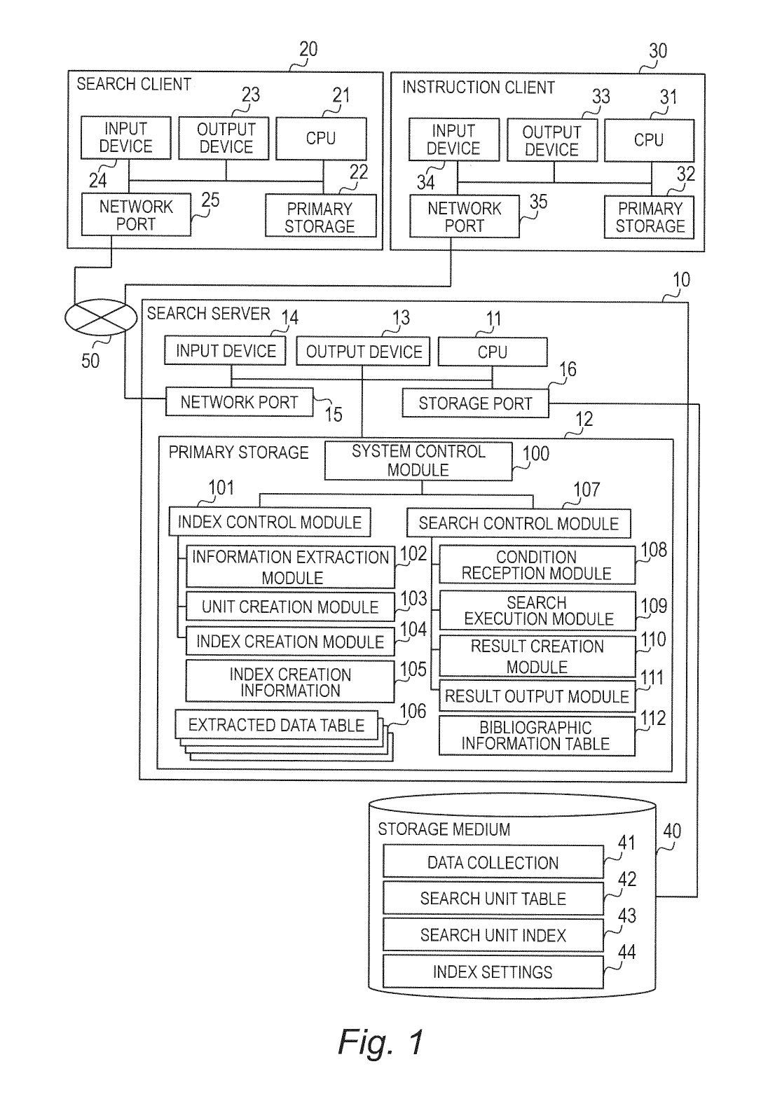

FIG. 1 is a block, diagram illustrating a physical configuration and a logical configuration of a computer system in this embodiment.

The computer system in this embodiment includes a search server 10, a search client 20, an instruction client 30, a storage medium 40, and a network 50. The search server 10 is a computer for reorganizing a plurality of pieces of data.

The search client 20 is a computer for inputting search conditions to the search server 10 and for receiving search results from the search server 10. The instruction client 30 is a computer for inputting conditions to combine pieces of data to the search server 10.

The storage medium 40 is a storage device for holding data to be searched. The storage medium 40 may be any kind of device as far as it is a storage device for holding data, such as a hard disk drive or an SSD (Solid State Drive).

The network 50 connects the search server 10, the search client 20, and the instruction client 30. The network 50 can be a LAN or the Internet.

Although the search server 10, the search client 20, and the instruction client 30 in FIG. 1 are implemented in different apparatuses, all the computers may be implemented in a single apparatus or otherwise at least two computers may be implemented in a single apparatus.

Although the search server 10 and the storage medium 40 in FIG. 1 are implemented in different apparatuses, they may be implemented in a single apparatus.

The search client 20 includes physical components of a CPU 21, a primary storage 22, an output device 23, an input device 24, and a network port 25. The physical components of the search client 20 are interconnected by a bus.

The CPU 21 is a computing device for executing programs held in the primary storage 22. The CPU 21 may be any type of processor other than a CPU (Central Processor Unit) as far as it is a computing device. The primary storage 22 is a storage device for holding programs and data.

The output device 23 is connected with a printer, a display, or the like to output results of processing in the search server 10. The input device 24 is connected with a mouse or a keyboard to receive instructions from the user. The output device 23 and the input device 24 may be connected with a device capable of inputting and outputting, such as a touch panel.

The network port 25 is a port for the search client 20 to connect to the network 50.

The instruction client 30 includes physical components of a CPU 31, a primary storage 32, an output device 33, an input device 34, and a network port 35. The physical components of the instruction client 30 are interconnected by a bus.

The CPU 31 is a computing device for executing programs held in the primary storage 32. The CPU 31 may be any type of processor other than a CPU as far as it is a computing device. The primary storage 32 is a storage device for holding programs and data.

The output device 33 is connected with a printer, a display, or the like to output results of processing in the search server 10. The input device 34 is connected with a mouse or a keyboard to receive instructions from the user. The output device 33 and the input device 34 may be connected with a device capable of inputting and outputting, such as a touch panel.

The network port 35 is a port for the instruction client 30 to connect to the network 50.

The search server 10 includes physical components of a CPU 11, a primary storage 12, an output device 13, an input device 14, a network port 15, and a storage port 16. The physical components of the instruction client 30 are interconnected by a bus.

The CPU 11 is a computing device for executing programs held in the primary storage 12. The CPU 11 may be any type of processor other than a CPU as far as it is a computing device. The primary storage 12 is a storage device for holding programs and data.

The output, device 13 is connected with a printer, a display, or the like to output results of processing in the search server 10. The input device 14 is connected with a mouse or a keyboard. The output device 13 and the input device 14 may be connected with a device capable of inputting and outputting, such as a touch panel.

The network port 15 is a port for the search server 10 to connect to the network 50. The storage port 16 is a port for the search server 10 to connect to the storage medium 40.

The primary storage 12 stores programs for implementing functions of the search server 10, including a system control module 100, an index control module 101, an information extraction module 102, a unit creation module 103, an index creation module 104, a search control module 107, a condition reception module 108, a search execution module 109, a result creation module 110, and a result output module 111.

The primary storage 12 in FIG. 1 further stores index creation information 105, a bibliographic information, table 112, and at least one extracted data, table 106. The index creation information 105, the extracted data table 106, and the bibliographic information table 112 may be stored in an apparatus different from the apparatus implementing the search server 10.

The system control module 100 controls the index control module 101 and the search control module 107. The index control module 101 controls the information extraction module 102, the unit creation module 103, and the index creation module 104. The search control module 107 controls the condition reception module 108, the search execution module 109, the result creation module 110, and the result output module 111.

The information extraction module 102 acquires designated pieces of data from data collection 41 and extracts bibliographic information from the acquired pieces of data. The information extraction module 102 then stores the extracted bibliographic information to the bibliographic information table 112.

The unit creation module 103 stores combinations of at least one piece of data in the data collection 41 and a search unit to a search unit table 42 based on the bibliographic information table 112. The index creation module 104 creates a search unit index 43 using the search units stored in the search unit table 42.

The condition reception module 108 acquires search conditions. The condition reception module 108 then converts the acquired search conditions into a format for the processing of the search execution module 109.

The search execution module 109 searches the search unit index 43. The result creation module .110 extracts data from the data collection 41 using the search unit table 42 and combines the extracted data to create a search result.

The result output module 111 sends the search result created by the result creation module 110 to the search client 20.

The index creation information 105 is information to designate pieces of data In the data collection 41. The extracted data table 106 indicates pieces of data extracted in accordance with the combination of users that exchange messages. The bibliographic information table 112 includes bibliographic information of the pieces of data in the data collection 41.

In this embodiment, the search server 10 implements its functions with programs; however, the functions of the search server 10 may be implemented with a. physical device such as an integrated circuit. The index creation information 105, the bibliographic information table 112, and the extracted data table 106 in this description each hold information in a table format; however, the index creation, information 105, the bibliographic information table 112, and the extracted data table 106 in this embodiment may hold information in any format, such as CSV.

The storage medium 40 illustrated in FIG. 1 includes a data collection 41, a search unit table 42, a search unit index 43, and index settings 44. The storage medium 40 is connected with the search server 10 via the storage port 16 in the search server 10.

The data collection 41 stores data of messages exchanged by a plurality of users. The search unit table 42 stores search units reorganized by the unit creation module 103. The search unit index 43 stores index terms and search units. The index settings 44 stores parameters for specifying the policy to create search units.

The data collection 41, the search unit table 42, and the search unit index 43, and the index settings 44 may be stored in the primary storage 12 or in an apparatus different from the apparatus implementing the storage medium 40.

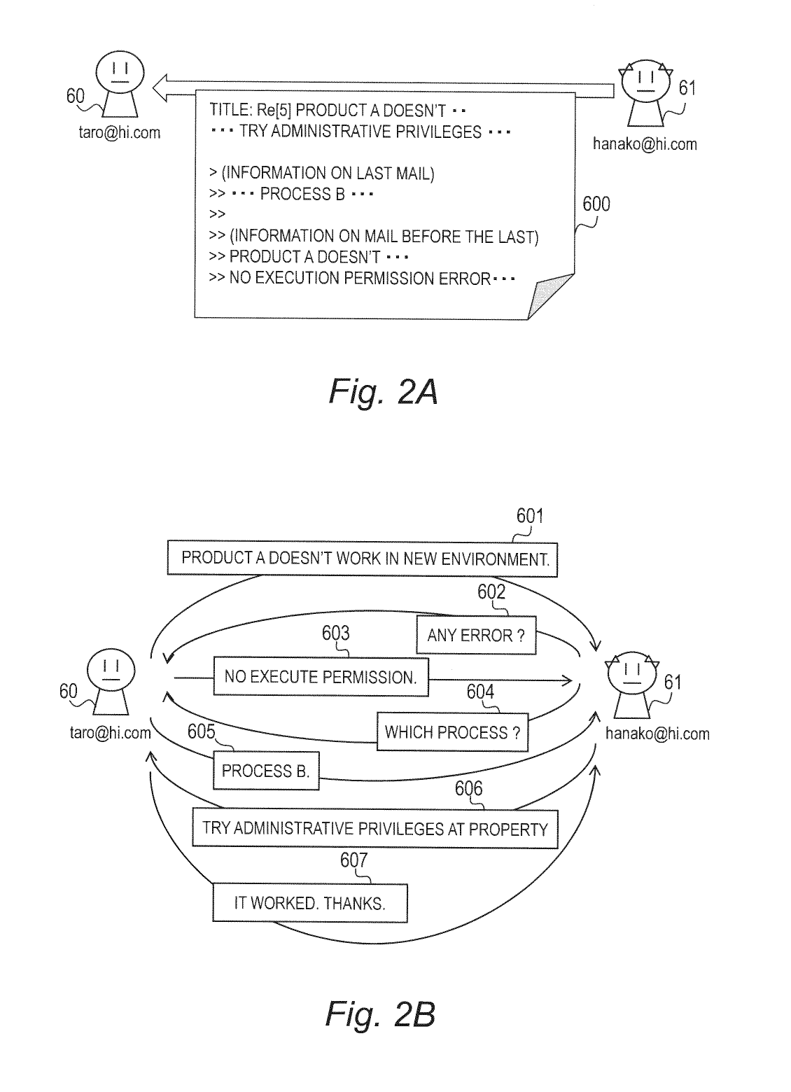

FIG. 2A is an explanatory diagram illustrating an example of a message transmitted by e-mail in this embodiment.

The message 600 in FIG. 2A is a message transmitted from a user 61 to a user 60 by e-mail. The address of the user 60 is taro@hi.com and the address of the user 61 is hanako@hi.com. The message 600 includes information exchanged between the users 60 and 61 as a history.

Specifically, the message 600 includes a topic between the users 60 and 61 as information understandable by the users. The information understandable by the users is a context on the topic, which includes the background and development of the topic and the description of the background and development of the topic.

Accordingly, the one message 600 or one piece of data allows a computer to effectively retrieve information on a single theme exchanged between the users 60 and 61.

Although the message illustrated in FIG. 2A is an e-mail, a piece of data that is effectively searchable by a computer may be an electronic patent specification, literature, news article, or blog article.

FIG. 2B is an explanatory diagram illustrating a plurality of messages on one theme in this embodiment.

Each of the messages 601 to 607 in FIG. 2B includes a fragment of the information included in the message 600. The user 60 sends a part of the message 600 to the user 61 as a message of an inquiry or a response.

The messages 601 to 607 in FIG. 2B are messages transmitted by an SMS, for example. The data, corresponding to each of the messages 601 to 607 is independent.

In the case of FIG. 2A where the user 60 receives the message 600 from the user 61, if a computer searches all the data of the messages exchanged between the users 60 and 61. with search conditions of “product A” “execute permission”, and “error”, the computer can acquire a search result indicating a solution “try administrative privileges . . . ” in the message 600. This is because the data of the message 600 includes texts of “product A doesn't . . . ” and “no execute permission error . . . ”

In the case of FIG. 2B where the users 60 and 61 exchange messages 601 to 607, however, if a computer searches all the messages exchanged between the users 60 and 61 with search conditions of “product A” “execute permission”, and “error”, the computer cannot acquire a search result.

This is because the messages 601 to 607 do not include a message including all the search conditions of “product A” “execute permission”, and “error” and further, because the text indicating a solution is included in a message different, from the messages including “product A”, “execute permission”, or “error”.

Another example of a conversation using an electric messenger system is provided as follows.

DATA 1: From USER1 To USER2 “My children have grown and it's difficult to make ends meet.”

### DATA2: From USER2 To USER1 “Why”

DATA3: From USER1 To USER2 “Expenses increase but my salary doesn't.”
DATA4: From USER2 To USER1 “Why don't you find a job with a better salary”
DATA5: From USER1 To USER2 “Such as?”
DATA6: From USER2 To USER1 “How about Company X (of a manufacturer originated from an emerging country)”

### DATA: From USER1 To USER2 “Can I?”

DATA8: From USER2 To USER1 “I think you have a great know-how.”
DATA9: From USER1 To USER2 “Maybe I will check job search sites.”

The foregoing conversation is messages exchanged between two employees (USER 1 and USER2) through devices owned by a company. The foregoing DATA1 to DATA9 each correspond to one of a plurality of pieces of data.

The personnel of this company monitor conversations for interferences with internal rules. To this end, the personnel want to extract employees' problematic conversations with search conditions of “Company X” and “job search”. In this situation, since each of the texts “Company X” and “job search” is included in a different piece of data, the personnel cannot extract the employees' problematic conversation.

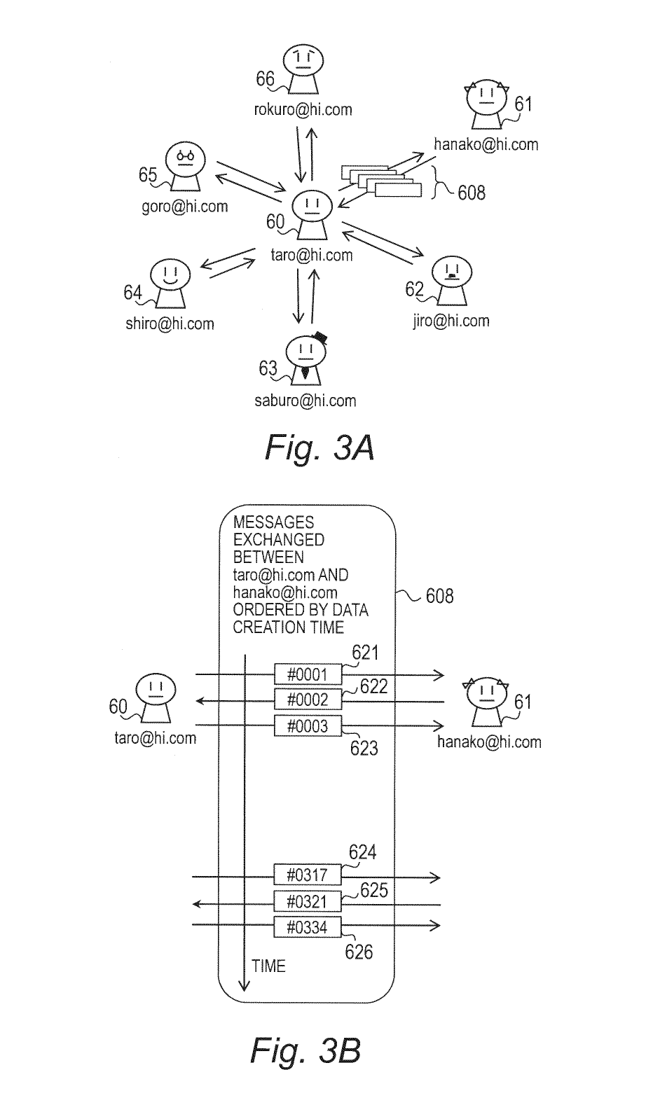

FIG. 3A is an explanatory diagram illustrating messages exchanged by a plurality of users in this embodiment.

The user 60 in FIG. 3A exchanges messages on a plurality of themes with a plurality of users (user 61 to user 66). The user 60 in FIG. 3A exchanges a plurality of messages 608 with the user 61.

The address of the user 62 is jiro@hi.com; the address of the user 63 is saburo@hi.com; the address of the user 64 is shiro@hi.com; the address of the user 65 is goro@hi.com; and the address of the user 66 is rokuro@hi.com.

When the user 60 reorganizes information in his brain based on a plurality of messages each including a fragment of information on one theme, the user reorganizes information based on the plurality of messages that the user 60 have read. Accordingly, this embodiment, assumes the user 60 is unlikely to reorganize information on one theme based on a plurality of messages exchanged with a plurality of users.

In this assumption, the messages on one theme are likely to be included in the messages exchanged with one user among the messages exchanged by the user 60. Accordingly, this embodiment assumes that the search server 10 can probably obtain information on one theme if it reorganizes a plurality of messages exchanged with one specific user into a group.

However, the plurality of messages exchanged between the user 60 and the specific user may include fragments of information on different themes.

FIG. 3B is an explanatory diagram illustrating messages exchanged between two users in this embodiment.

FIG. 3B illustrates a plurality of messages 608 exchanged between the user 60 and the user 61 in FIG. 3A ordered by the creation time. The flow of time indicated in FIG. 3B corresponds to the actual time. The plurality of messages 608 include messages 621 to 626. The messages 621 to 626 are individually assigned identifiers (#0001) to (#0003), (#0317), (#0321), and (#0334).

The difference in creation time between the message (#0001) 621 and the message (#0002) 622 and the difference in creation time between the message (#0002) 622 and the message (#0003) 623 are distinctly small compared to the difference in creation time between the message (#0003) 623 and the message (#0317) 624.

In general, a conversation on one theme is likely to be held continuously and conversations held in different periods are likely to be about different themes.

The message (#0001) 621, the message (#0002) 622, and the message (#0003) 623 include information about “product A” and “process B”. The message (#0317) 624, the message (#0321) 625, and the message (#0334) 626 include information about “product C” and “process D”.

If the computer combines all the data in the messages 608 In FIG. 3B into a group of data and conducts a full-text search of the combined data with a keyword of “product C” or “process B”, the computer obtains search results of the data of the message (#0001) 621, the message (#0002) 622, the message (#0003) 623, the message (#0317) 624, the message (#0321) 623, and the message (#0334) 626.

These obtained search results include unnecessary data (noises). Specifically, in the case where the keyword is “product C”, the message (#0001) 621, the message (#0002) 622, the message (#0003) 623 in the obtained search results are the noises. In the case where the keyword is “process B”, the message (#0317) 624, the message (#0321) 625, and the message (#0334) 626 in the obtained search results are the noises.

For this reason, the search server 10 in this embodiment reorganizes the message (#0001) 621, the message (#0002) 622, the message (#0003) 623 as a single search unit, reorganizes the message (#0317) 624, the message (#0321) 625, and the message (#0334) 626 as another search unit, and searches the plurality of reorganized search units to achieve low noise in the search results.

To achieve this object, the search server 10 in this embodiment acquires the creation times of the plurality of messages and acquires the differences between creation times of the messages. The search server 10 calculates the average of the acquired differences and determines an interval between two messages having a difference larger than the calculated average to be a boundary of search units.

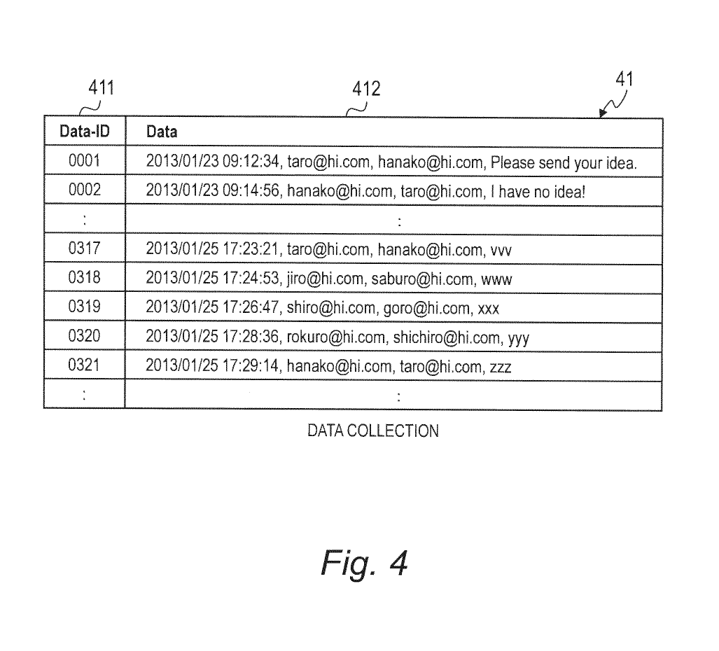

FIG. 4 is an explanatory diagram illustrating a data collection 41 in this embodiment.

The data collection 41 stores pieces of data on the messages to be searched by the search server 10. The stored in the data collection 41 are pieces of data on the messages exchanged between users. The data collection 41 includes Data-IDs 411 and Data 412.

The Data-IDs 411 uniquely identify individual messages and indicate the identifiers (hereinafter, referred, to as Data-ID) of data included in the individual messages. The Data 412 indicates data included in the individual messages. The Data-IDs can be numerical values or letters.

A piece of Data 412 includes data of a message transmitted between users. The Data 412 in this embodiment includes a creation time of the data of the message, the sender address and the recipient address when the data is transmitted as a message, and the body of the message.

The search server 10 may acquire the data of the messages exchanged by users from the communication carrier or the messenger software. The system control module 100 of the search server 10 stores the acquired data of the messages to the data collection 41 and assigns Data-IDs to individual pieces of the acquired data of the messages.

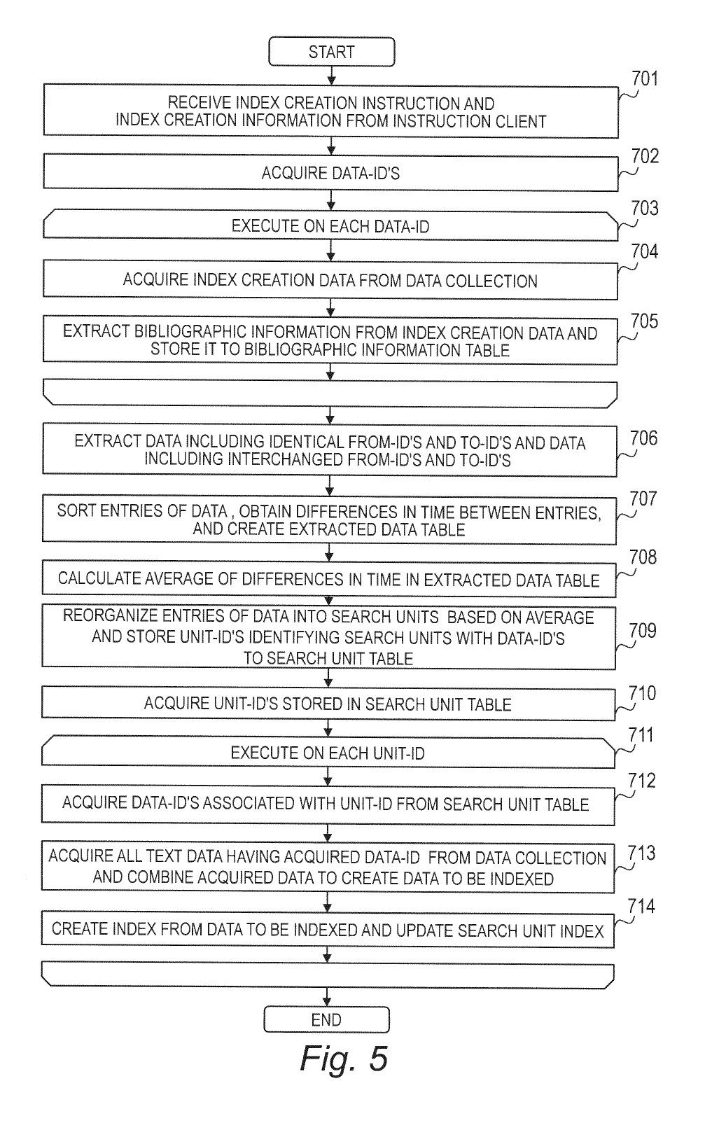

FIG. 5 is a flowchart illustrating processing of creating search units in this embodiment.

The instruction client 30 receives an index creation instruction and index creation information input by the administrator or an operator (hereinafter, operator) of the computer system of this embodiment. The instruction client 30 sends the index creation instruction and the index creation in formation to the search server 10.

When the instruction client 30 sends the index creation instruction and index creation information, the system control module 100 of the search server 10 receives the index creation instruction and index creation information (701). The system control module 100 stores the received index creation information to the primary storage 12 as index creation information 105.

The index creation instruction is an instruction to reorganize the data of a plurality of messages included in the data collection 41 into at least one search unit and to create an index for the search units. The index creation information 105 includes values to designate the data of a plurality of messages included in the data collection 41.

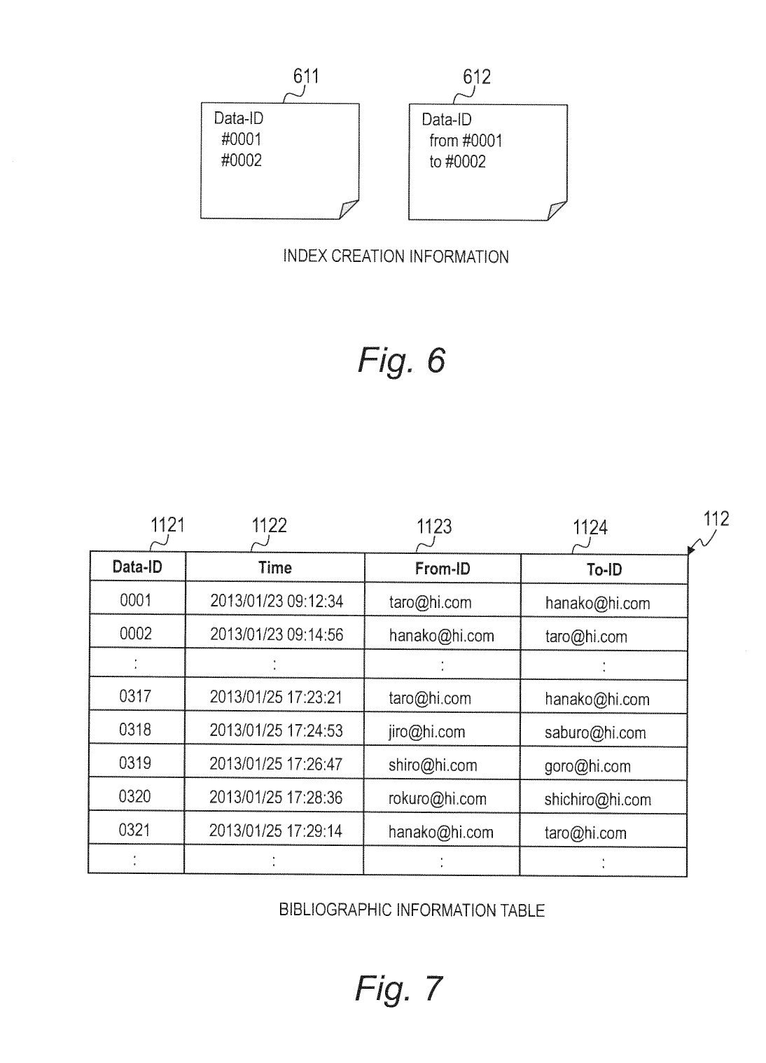

FIG. 6 is an explanatory diagram illustrating examples of index creation information 105 in this embodiment.

The index creation information 105 designates pieces of Data 412 for which a search index is to be created among the pieces of Data 412 of the messages included in the data collection 41. FIG. 6 shows two examples of index creation information 105: index creation information 611 and index creation information 612.

The index creation information 611 designates the pieces of Data 412 for which an index is to be created with Data-IDs. The index creation information 611 includes at least one Data-ID. The index creation information 612 designates the pieces of Data 412 for which an index is to be created with a range of value to include Data-IDs.

The term “from” in the index creation information 612 in FIG. 6 specifies the beginning of the range of value for the Data-IDs to be included. The term “to” in the index creation information 612 in FIG. 6 specifies the end of the range of value for the Data-IDs to be included.

The index creation information 612 needs to specify at least either the beginning or the end of the range of value. Taking an example of a case where the index creation information 612 specifies a value for “from” without specifying a value for “to”, the information extraction module 102 of the search server 10 extracts the pieces of Data 412 having the Data-IDs of the value for “from” to the last value from the data collection 41 as the data for which an index is to be created.

Taking an example of another case where the index creation information 612 specifies a value for “to” without specifying a value for “from”, the information extraction module 102 of the search server 10 extracts the pieces of Data 412 having the Data-IDs of the first value to the value for “to” from the data collection 41 as the data for which an index is to be created.

Although the index creation information 105 illustrated in FIG. 6 designates the pieces of Data 412 with Data-IDs, the index creation information in this embodiment may designate at least one piece of data with the time or the period of data creation indicated in the Data 412.

Alternatively, the index creation information 105 in this embodiment may designate the pieces of Data 412 for which an index is to be created with the sender address or the recipient address indicated in the Data 412. Still alternatively, the index creation information 105 in this embodiment may designate the pieces of Data 412 for which an index is to be created with at least two kinds of information among the Data-ID, the time, the period, the sender address, and the recipient address.

After Step 701, the system control module 100 invokes the index control module 101 and the index control module 101 invokes the information extraction module 102. The information extraction module 102 acquires the Data-IDs specified by the index creation information 105 (702).

After Step 702, the information extraction module 102 executes Steps 704 and 705 on each of the acquired Data-IDs (703).

The information extraction module 102 acquires an entry assigned one of the acquired Data-IDs from the data collection 41 as index creation data (704). The information extraction module 102 extracts a Data-ID (corresponding to a Data-ID 411) and bibliographic information from the acquired index creation data and. stores the extracted Data-ID and the bibliographic information to the bibliographic information table 112 (705).

FIG. 7 is an explanatory diagram illustrating a bibliographic information table 112 in this embodiment.

The bibliographic information table 112 stores at least one kind of bibliographic information of the data for which an index is to be created. The bibliographic information table 112 is an area that does not include any value at the start of the processing illustrated in FIG. 5; the values are stored through the processing of Step 705. The bibliographic information table 112 stores Data-IDs 1121, Times 1122, From-IDs 1123, and To-IDs 1124.

Each Data-ID 1121 indicates a Data-ID and corresponds to a Data-ID 411 in the data collection 41. Each Time 1122 indicates a time when the data of the message is created and corresponds to the time included in the Data 412.

Each From-ID 1123 indicates the sender address when the Data 412 is sent as a message and corresponds to the sender address included in the Data 412. Each To-ID 1124 indicates the recipient address when the Data 412 is sent as a message and corresponds to the recipient address included in the Data 412.

At Step 705, the information extraction module 102 extracts a Data-ID from the Data-ID 411 in the index creation data and further, extracts the time, sender address, and recipient address in the Data 412 from the index creation data as bibliographic information. The information extraction module 102 stores the extracted Data-ID, time, sender address, and recipient address respectively to the Data-ID 1121, Time 1122, From-ID 1123, and To-ID 1124 in the bibliographic information table 112.

The information extraction module 102 holds a template for the Data 412 in advance and extracts the time, sender address, and recipient address from the Data 412 based on the template in the information extraction module 102.

After the information extraction module 102 executes Steps 704 and 705 on all the Data-IDs acquired at Step 702, the index control module 101 invokes the unit creation module 103.

Upon invocation, the unit creation module 103 extracts all entries including a pair of identifiers of a From-ID 1123 and a To-ID 1124 in one entry as a combination of a From-ID 1123 and a To-ID 1124 or a combination of a To-ID 1124 and a From-ID 1123 from the bibliographic information table 112. That is to say, the unit creation module 103 extracts all entries indicating the bibliographic information of the messages exchanged between two specific users. The unit creation module 103 creates a group of data including the extracted entries (706).

If the bibliographic information table 112 includes a plurality of pairs for the combinations of a From-ID 1123 and a To-ID 1124 or the combinations of a To-ID 1124 and a From-ID 1123, meaning if the bibliographic information table 112 includes bibliographic information of messages exchanged by a plurality of pairs of users, the unit creation module 103 creates a plurality of groups of data at Step 706. As a result, the unit creation module 103 can group the messages of a plurality of pairs of users as illustrated in FIG. 3A into the messages of the individual pairs of users.

After Step 706, the unit creation module 103 sorts the entries included in each of at least one created group of data by the Time 1122. The unit creation module 103 obtains differences in Time 1122 between two consecutive entries in the sorted group of data. The unit creation module 103 stores the sorted group of data and obtained differences to an extracted data table 106 (707).

If a plurality of groups of data are created at Step 706, the unit creation module 103 creates a plurality of extracted data table 106 for the individual groups of data at Step 707. The unit creation module 103 executes Step 708 on each of the plurality of extracted data tables 106.

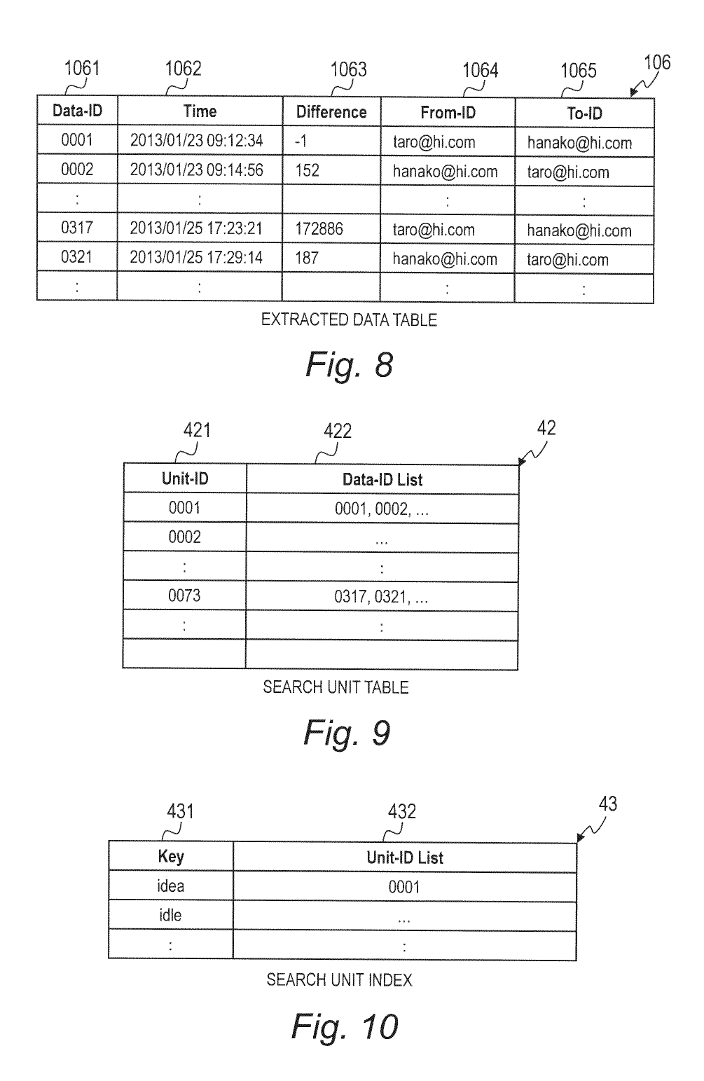

FIG. 8 is an explanatory diagram illustrating an extracted data, table 106 in this embodiment.

The extracted data table 106 includes information on a group of data and differences in creation time between messages. The extracted data table 106 is an area that does not include any value at the start of the processing illustrated in FIG. 5. The extracted data table 106 stores Data-IDs 1061, Times 1062, Differences 1063, From-IDs 1064, and To-IDs 1065.

Each Data-ID 1061 corresponds to a Data-ID 1121 in the bibliographic information table 112 and a Data-ID 411 in the data collection 41. Each time 1062 corresponds to a Time 1122 in the bibliographic information table 112. Each From-ID 1064 corresponds to a From-ID 1123 in the bibliographic information table 112. Each To-ID 1065 corresponds to a To-ID 1124 in the bibliographic information table 112.

The Data-IDs 1061, Times 1062, Differences 1063, From-IDs 1064, and To-IDs 1065 are the group or data sorted by the Time 1122 at Step 707.

Each Difference 1063 includes a difference in time obtained at Step 707. The Difference 1063 includes a difference in creation time between the data identified by a Data-ID 1061 and the last data created before the data.

For example, the Difference 1063 of the entry having a Data-ID 1061 of “0002” indicates the difference between the value of the Time 1062 of the entry including a Data-ID 1061 of “0002” and the value of the Time 1062 of the entry including a Data-ID 1061 of “0001”.

The unit creation module 103 in this embodiment stores indicating an invalid value in the Difference 1063 of the first entry in the sorted group of data at Step 707.

After Step 707, the unit creation module 103 extracts values other than the invalid value (“−1” in this embodiment) from the Differences 1063 of the extracted data table 106 and calculates the average of the extracted values (708).

After Step 708, the unit creation module 103 compares each of the Differences 1063 with the average calculated at Step 708 and determines that an entry including a Difference 1063 larger than the average and the previous entry is sparse. The unit creation module 103 separates the two entries determined to be sparse into different search units at the interval therebetween to create a plurality of search units.

Using a difference (Difference 1063) between Times 1062 and the average of the differences (Differences 1063) at Step 708, the unit creation module 103 determines the density of distribution of Times 1122 in the bibliographic information table 112. Among the entries determined about density, the unit, creation module 103 groups the entries of the extracted data table 106 by separating two entries that are determined to be sparse into different search units at the interval therebetween to create search units including grouped entries.

The unit creation module 103 accordingly can reorganize the data of the messages on one theme exchanged between two users in a certain period into a search unit.

The unit creation module 103 assigns identifies (Unit-IDs) uniquely identifying the created search units. The unit creation module 103 associates each Unit-ID with at least one Data-ID (corresponding to the Data-ID 1061) included in the search unit, and stores them to the search unit table 42 (709).

FIG. 9 is an explanatory diagram Illustrating a search unit table 42 In this embodiment.

The search unit table 42 indicates correspondence relations between a search unit and pieces of data included in the search unit. The search unit table 42 is an area that does not include any value at, the start of the processing illustrated in FIG. 5. The search unit table 42 stores Unit-IDs 421 and Data ID lists 422.

Each Unit-ID 421 includes a Unit-ID assigned at Step 709. Each Data-ID List 422 includes the Data-ID of at least one entry of data included in the search unit created at Step 709.

The unit creation module 103 stores all Data-IDs included in a created search unit to a Data-ID List 422 at Step 709. If a plurality of extracted data tables 106 exist, the unit creation module 103 may store the Unit-IDs of all the search units created from the plurality of extracted data tables 106 into a single search unit table 42. The Unit-IDs in this example uniquely identify the plurality of search units created from all the extracted data tables 106.

After Step 709, the index control module 101 invokes the index creation module 104. Upon invocation, the invoked index creation module 104 acquires all the values of the Unit-IDs 421 in the search unit table 42 (710).

The index creation module 104 executes Steps 712 to 714 on each of the acquired Unit-IDs (711).

The index creation module 104 acquires the Data-IDs associated with one Unit-ID (hereinafter, Unit-ID a) of the Unit-IDs acquired from the Data-ID list 422 in the search unit table 42 (712). After Step 712, the index creation module 104 refers to the data collection 41 and acquires message bodies from all the Data 412 having the acquired Data-IDs. The index creation module 104 combines the acquired at least one message body to create data to be indexed (713).

After Step 713, the index creation module 104 parses the data to be indexed and extracts at least one index term from the data to be indexed. The index creation module 104 associates the extracted index terms with the Unit-ID a and stores them in the search unit index 43. If the search unit index 43 already includes a value of an extracted index term, the index creation module 104 adds the Unit-ID a to the entry corresponding to the extracted index term (714).

After executing Steps 712 to 714 on all the search units, the system control module 100 exits the processing illustrated In FIG. 5.

FIG. 10 is an explanatory diagram illustrating a search unit index 43 in this embodiment.

The search unit index 43 is a transposed index to retrieve search units with an index term. The search unit index 43 includes Keys 431 and Unit-ID Lists 432.

Each Key 431 indicates an index term extracted at Step 714. Each Unit-ID List 432 indicates Unit-IDs of the search units including the data from which the index term of the Key 431 is extracted.

The search unit index 43 illustrated in FIG. 10 is a word index; the Keys 431 contain words. However, the search unit index in this embodiment mat be any kind of index, such as an n-gram index or a B-tree index.

The processing illustrated in FIG. 5 enables the search server 10 in this embodiment to create a search unit index 43 that can provide search units of search results by reorganizing messages into search units, even if information on one theme is separately included in a plurality of messages.

The above-described Steps 708 and 709 determines the density of distribution of Times 1062 by comparing each Difference 1063 with the average of the Differences 1063 in creating search units. However, the unit creation module 103 in this embodiment may employ any policy to reorganize a group of data into search units. For example, the unit creation module 103 may compare each Difference 1063 with a predetermined threshold m (where the threshold m is any positive number) to determine that an entry including a Difference 1063 larger than the predetermined threshold m and the previous entry thereof are sparse.

Alternatively, the unit creation module 103 may compare each Difference 1063 with a value of n times (where the parameter n is any positive number) of the average of the Differences 1063 to determine the density of distribution of Times 1062, in creating search units at Step 709.

The foregoing threshold m or parameter n, and the policy to create search units may be specified with the index creation information 105 received from the instruction client 30 at Step 701. Alternatively, the values Indicating the threshold m or parameter n and the policy to create search units may be specified in the later-described index settings 44. In the case where the values are specified in the index settings 44, the unit creation module 103 retrieves the index settings 44 at Step 708 and creates search units in accordance with the index settings 44.

At Step 709, if the number of messages included in a reorganized search unit is smaller than a predetermined minimum value, the unit creation module 103 may include the messages included in this search unit in both of the previous search unit, and the next search unit.

The predetermined minimum value may be specified with the index creation information 105 received from the instruction client 30 at Step 701. Alternatively, the predetermined minimum value may be stored in the later-described index settings 44 in advance; the unit creation module 103 may retrieve the index settings 44 at Step 708.

Hereinafter, a specific example of joining search units is described.

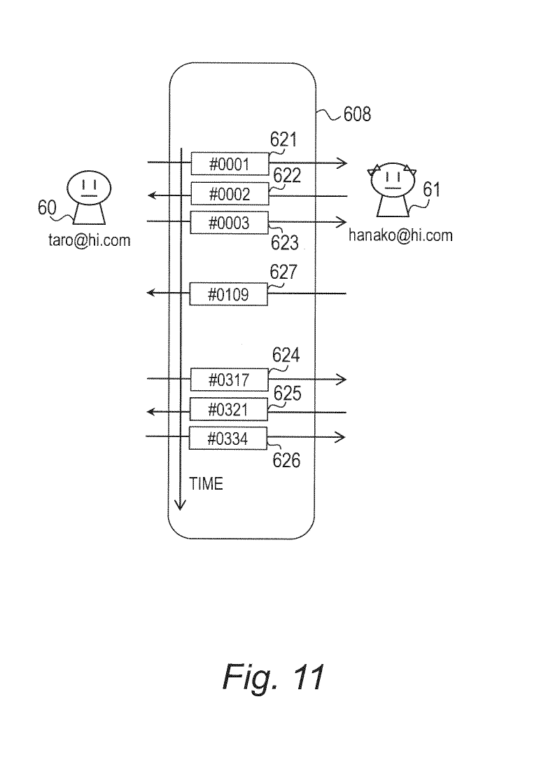

FIG. 11 is an explanatory diagram illustrating a concept of joining search units in this embodiment.

In FIG. 11, when, a predetermined time or more has passed since the end of exchange of the message (#0001) 621, message (#0002) 622, and message (#0003) 623, the user 61 sends another message (#0109) 627 to the user 60. Furthermore, the message (#0317) 624, message (#321) 625, and message (#0334) 626 are exchanged after another predetermined time or more has passed.

Like this case, a small number of messages may be exchanged separately from the other large number of messages. The small number of messages may include fragments of the same information in the other large number of messages. If such a small number of messages are reorganized into a single search unit, a search may results in some retrieval omission.

In the case of employing the foregoing policy to create a search unit using the average of differences in time, however, it is difficult for the unit creation module 103 to determine whether the message (#0109) 627 includes the same information as the search unit composed of the message (#0001) 621, message (#0002) 622, and message (#0003) 623 or the search unit composed of the message (#0317) 624, message (#321) 625, and message (#0334) 626.

Accordingly, if the number of messages included in a created search unit is smaller than a predetermined minimum value like the message (#0109) 627, the unit creation module 103 duplicates the messages included in the search unit at Step 709 and includes the messages in both of the search unit composed of the message (#0001) 621, message (#0002) 622, and message (#0003) 623 and the search unit composed of the message (#0317) 624, message (#321) 625, and message (#0334) 626. The unit creation module 103 in this embodiment can prevent retrieval omission with this operation.

In this case, the search unit table 42 in FIG. 9 Includes the Data-ID of the message (#0109) 627 in the entry including the Data-IDs of the message (#0001) 621, message (#0002) 622, and message (#0003) 623 and in addition, includes the Data-ID of the message (#0109) 627 in the entry including the Data-IDs of the message (#0317) 624, message (#321) 625, and message (#0334) 626.

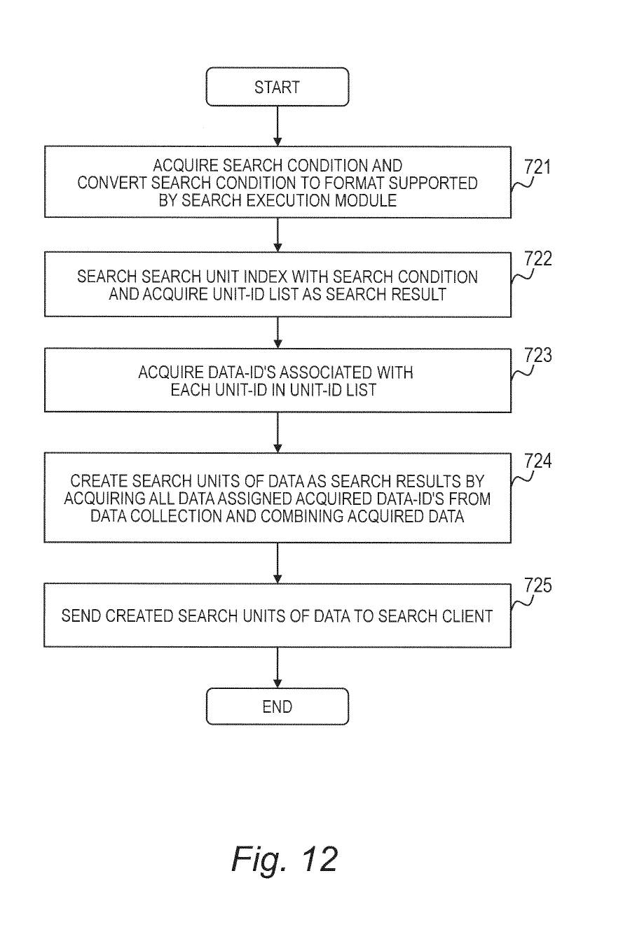

FIG. 12 is a flowchart illustrating search processing on a search unit basis in this embodiment.

The input device 24 of the search client 20 receives a search condition from the operator of the search client 20 and the CPU 21 sends the received search condition to the search server 10 via the network 50.

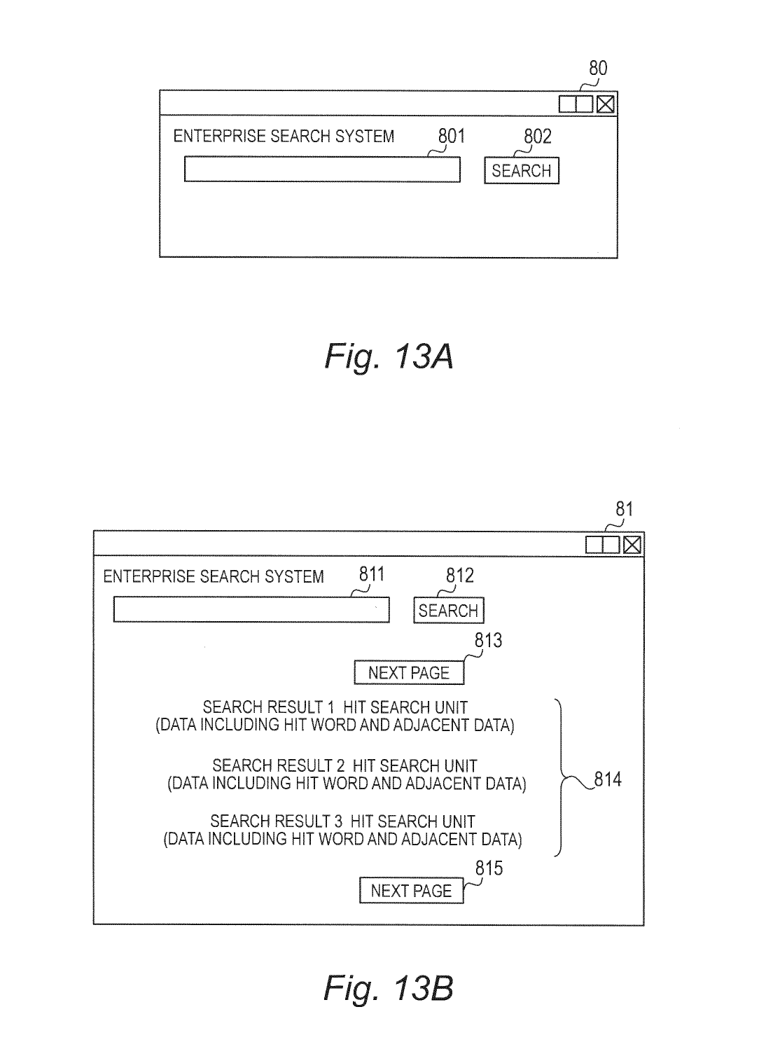

FIG. 13A is an explanatory diagram illustrating an example of a screen for inputting a search condition to be displayed on the search client 20 in this embodiment.

The screen 80 shown in FIG. 13A is displayed on the output device 23 of the search client 20. The operator of the search, client 20 inputs a search condition to the search client 20 with the screen 80 and the input device 24. The search condition may be a word included in the data that the operator wants to obtain.

The screen 80 includes an entry field 801 and a button 802. The entry field 801 is a field to input a search condition or a word. A plurality of words may be input to the entry field 801. In the case where a plurality of words are input to the entry field 801, the condition reception module 108 may join the individual words with an or condition at later-described Step 721 to convert the acquired search conditions into search conditions conformable to the processing of the search execution module 109.

Alternatively, the operator may input logical conditions to the entry field 801 in accordance with a predefined notation so that the condition reception module 108 may convert the search conditions in accordance with the predefined, notation.

The button 802 is a field to make the search client 20 receive the search condition, input to the entry field 801. The operator sends the search condition to the search server 10 by operating the button 802 to make the search server 10 execute search processing. In response to the operation, the processing illustrated in FIG. 12 starts.

The screen 80 illustrated in FIG. 13A is merely an example; a screen in any configuration may be used as far as the screen can accept input of a search condition. Although the foregoing has described an example where the search condition is input to the search client 20, the operator may input the search condition directly to the search server 10. In the case where the operator inputs the search condition directly to the search server 10, the output device 13 of the search server 10 displays the screen 80, for example.

Upon receipt of the search condition from the search client 20, the system control module 100 of the search server 10 invokes the search control module 107. The search control module 107 invokes the condition reception module 108. The system control module 100 inputs the search condition to the condition reception module 108 with the search control module 107.

Upon invocation, the condition reception module 108 acquires the search condition from the search control module 107. The condition reception module 108 converts the acquired search condition into a format supported by the search execution module 109 (721).

After Step 721, the search control module 107 invokes the search execution module 109. Upon invocation, the search execution module 109 searches the Keys 431 in the search unit index 43 with the search condition converted by the condition reception module 103 to acquire the values of the Unit-ID List 432 as search results of Step 722 (722).

After Step 722, the search control module 107 invokes the result creation module 110. Upon invocation, the result creation module 110 extracts at least one Unit-ID included in the Unit-ID List 432 acquired at Step 722. The result creation module 110 acquires Data-IDs associated with the extracted Unit-IDs from the Data-ID Lists 422 of the search unit table 42 (723).

After Step 723, the result creation module 110 acquires all Data 412 assigned the acquired Data-IDs from the data collection 41. The result creation module 110 combines all the acquired Data 412 to create search units of data depending on the individual Unit-IDs extracted at Step 723 as search results of the processing illustrated in FIG. 12 (724).

At Step 724, the result creation module 110 may combine the Data 412 by search unit or combine the Data 412 in accordance with the search condition. For example, the result creation module 110 may extract a message including the word of the search condition from the data acquired at Step 724. The result creation module 110 may further extract the last message created before and the next message created after the creation, of the extracted message from the data acquired at Step 724. The result creation module 110 may combine the message including the word of the search condition with the last message created before and the next message created after the creation of the message including the word.

If the number of messages to be output as search results has a predetermined upper limit, the result creation module 110 may extract messages of the number of the predetermined upper limit from the data acquired at Step 724 to combine the extracted messages.

Furthermore, the result creation module 110 may refer to the index settings 44 at Step 723 and, if the index settings 44 include settings about indication of the search results, combine the acquired data in accordance with the settings.

After Step 724, the search control module 107 invokes the result output module 111. Upon invocation, the result output module 111 sends search units of data created by the result creation module 110 to the search client 20 (725).

FIG. 13B is an explanatory diagram Illustrating an example of a screen for outputting a search result to be displayed on the search client 20 in this embodiment.

The screen 81 illustrated in FIG. 13B is displayed by the output device 23. The screen 81 is a screen to output search results obtained by the search server 10 through the processing illustrated in FIG. 12 for the operator. The screen 81 includes an entry field 811, a button 812, a button 813, a list 814, and a button 815.

The entry field 811 and the button 812 are the same as the entry field 801 and the button 812 on the screen 80. The operator uses the entry Held 811 and the button 812 if the operator wants to conduct a further search after seeing search results. These components improve the convenience for the operator. However, the screen 81 may include a button to switch to the screen 80 instead of the entry field 811. and the button 812.

The buttons 813 and 815 are buttons to indicate search results that are not indicated. For example, if the volume of the search results is more than the capacity of the size of the display of the output device 23, the output device 23 may display the buttons 813 and 815 on the screen 81. The operator can operate the button 813 or 815 to see the search results that are not indicated.

At least, either one of the button 813 and the button 815 needs to be displayed; however, the both of the buttons 813 and 815 may be displayed to increase the convenience for the operator.

The list 814 is a section to indicate search results. The list 814 indicates search units of data created at Step 724 in FIG. 12. If a plurality of search units are to be indicated in the list 814, the output device 23 may determine the order of indication of the search units in accordance with any priority (for example, the creation time of the data).

The output device 23 may indicate a predetermined number of search units in the list 814.

The screen 81 illustrated in FIG. 13B is merely an example; the output device 23 may display a screen in any configuration as far as the screen can output search results. Although the foregoing screen 81 is displayed on a display device, a printer connected with the output device 23 may output the list 814. Although the foregoing screen 81 is displayed by the output device 23 of the search client 20, the output device 13 of the search server 10 may display the screen 81 or output the list 814.

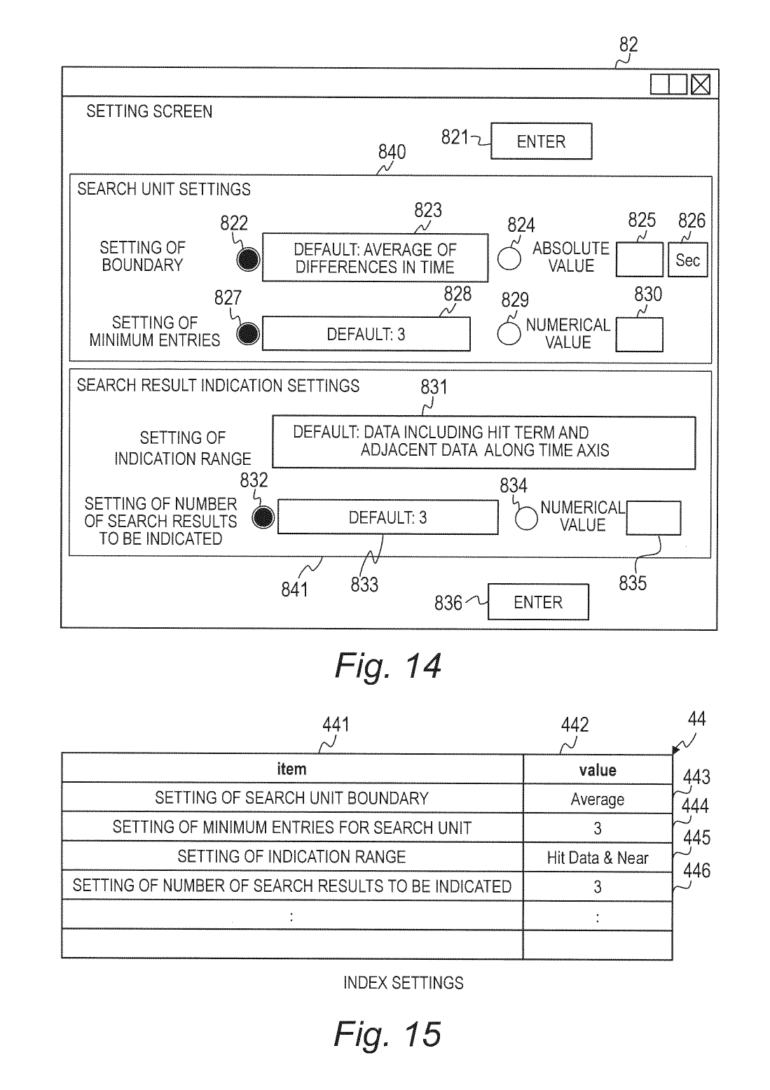

FIG. 14 is an explanatory diagram illustrating an example of a screen to specify index settings 44 in this embodiment.

The screen 82 illustrated in FIG. 14 is a screen to specify values for the index settings 44. The screen 82 is displayed by the output device 33 of the instruction client 30. The values entered through the screen 82 are sent from the instruction client 30 to the search server 10 and stored in the index settings 44 by the system control module 100.

The screen 82 includes a button 821, a button 836, a section 840, and a section 841. The section 840 includes a radio button 822, a list box 823, a radio button 824, an entry held 825, a list box 826, a radio button 827, a list-box 828, a radio button 829, and an entry field 830. The section 841 includes a list box 831, a radio button 832, a list box 833, a radio button 834, and an entry field 835.

The buttons 821 and 836 are buttons to send the values entered to the sections 840 and 841 to the search server 10. The operator operates the button 821. or 835 to store the values entered to the sections 840 and 841 to the index setting 44 in the search server 10.

The section 840 is a section to specify the values related to creation of search units. The section 841 is a section to specify the values related to indication of search results.

The radio button 822 is selected to specify the policy to create search units with the list box 823; it is indicated as active when it is selected. In the screen 82 in FIG. 14, when the radio button 822 is selected, the radio button 824 in FIG. 14 is indicated as deactive. This is because the list box 323 in FIG. 14 includes policies that do not use a parameter specified with the entry field 825 to create search units.

In FIG. 14, an active radio button may be indicated as a closed circle and a deactive radio buttons may be indicated as open circles.

The list box 823 is to select a policy to create search units. The list box 823 may provide a plurality of policies; the operator may select one of the plurality of policies indicated in the list box 823 to determine the policy.

The list box 823 may indicate a policy, such as “Default: Average of differences in time”, “Twice of average of differences in time”, or “½ times of average of differences in time”. The operator can specify the method and the parameter n to create search units at Steps 708 and 709 by selecting a policy in the list box 823.

The radio button 824 is selected to specify the parameter to create search units with the entry field 825 and the list box 826; the button is indicated as active if selected. When the radio button 824 is selected in the screen 82 in FIG. 14, the radio button 822 is indicated as deactive.

The entry field 825 is to input a numerical value for the parameter (the aforementioned threshold m) to create search emits at Step 709. The list box 826 is to input a unit of measure for the numerical value input to the entry held 825.

The list box 826 may indicate a plurality of units as a selection. In such a case, the operator selects one of the plurality of units indicated in the list box 826 to determine the unit.

The radio button 827 is selected to specify a minimum number for the messages included in a search unit with the list box 828; when the radio button 827 is selected, the radio button 829 is indicated as deactive.

The list box 828 indicates a selection for the minimum number of messages included in a search unit. The operator selects a minimum number of messages to be included in a search unit from the selection of, for example, “Default: 3”, “5”, and “7” indicated in the list box 828.

The radio button 829 is selected to specify the minimum number for the messages to be included in a search unit with the entry field 830; when the radio button 829 is selected, the radio button 827 is indicated as deactive. The entry field 830 is to input a minimum number for the messages to be included in a search unit.

The operator can specify the minimum number to be used at Step 709 by selecting a value in the list box 828 or inputting a value to the entry field 830.

The list box 831 is a field to input a condition for the search results to be indicated in the list 814 of the screen 81. The list box 831 in FIG. 14 provides a selection of conditions.

The list box 831 provides a selection including, for example, “Default: Data including hit term and adjacent data along time axis”, “Data including hit term regardless of time axis”, and “From the beginning on time axis”. The operator can specify the policy to combine messages in creating search units of data at Step 724 by selecting a value in the list box 831.

The radio button 832 is selected to specify the number of search results to be indicated in the list 814 of the screen 81 with the list box 833; when the radio button 832 is selected, the radio button 834 is indicated as deactive.

The list box 833 indicates a selection for the number of search results to be indicated in the list 814 of the screen 81. The operator selects the number of search results to be indicated from the selection including, for example, “Default: 3”, “1”, and “5”.

The radio button 834 is selected to specify the number of search results to be indicated in the list 814 of the screen 81 with the entry field 835; when the radio button 834 is selected, the radio button 832 is indicated as deactive.

The entry field 835 is a field to input the number of search results to be indicated in the list 814 of the screen 81.

After the operator selects a value from the list box 833 or inputs a value to the entry field 835, the result output module 111 may send data of search units in the number as specified in the list box 833 or the entry field 835 to the search client 20 at Step 725.

The screen 82 Illustrated in FIG. 14 is merely an example; the output device 33 may display a screen in any configuration as far as the index settings 44 can be specified through the screen. Although the above-described screen 82 is displayed by the output device 33 of the instruction client 30, the output device 13 of the search server 10 may display the screen 82.

FIG. 15 is an explanatory diagram illustrating index settings 44 in this embodiment.

The index, settings 44 indicate setting values for creating search units and setting values for indicating search results specified through the screen 82. The index settings 44 include items 441 and values 442.

The value 442 of the entry 443 indicates the value selected in the list box 823 or the value input to the entry field 825. The value 442 of the entry 444 indicates the value selected in the list box 828 or the value input to the entry field 830.

The value 442 of the entry 445 indicates the value selected in the list box 831. The value 442 of the entry 446 indicates the value selected in the list box 833 or the value input to the entry field 835.

The entry 443 is retrieved at Steps 708 and 709; the entry 444 is retrieved at Step 709; the entry 445 is retrieved at Step 724; and the entry 446 is retrieved at Step 725.

The screen 82 illustrated in FIG. 14 and the index settings 44 enable the operator to freely change the policy to create search units and the minimum value for the number of messages included in a search unit.

As described above, in the case where fragments of information on a single theme are separately included in a plurality of messages, this embodiment reorganizes correlative messages into a search unit to allow a search by the reorganized search unit. As a result, the search server 10 in this embodiment can output search results meaningful for the user.

Since the search server 10 uses the creation times of the messages in creating search units, messages included in search units can be extracted appropriately compared to the search units created only with bibliographic information. As a result, the search server 10 in this embodiment attains low noise in search results.

This invention is not limited to the above-described embodiment but includes various modifications. The above-described embodiments are explained in details for better understanding of this invention and are not limited to those including all the configurations and elements described above.

Although this embodiment reorganizes messages exchanged between two users into search units; this embodiment is applicable to any data as far as a plurality of pieces of data collectively indicate that the data is about a single theme but each piece does not indicate that the data is about the theme.

The above-described configurations, functions, and processors, for all or a part of them, may be implemented by hardware: for example, by designing an integrated circuit. The information of programs and tables to implement the functions may be stored in a storage device such as a memory, a hard disk drive, or an SSD (Solid State Drive), or a storage medium such as an IC card, or an SD card.

The drawings shows control lines and information lines as considered necessary for explanations but do not show all control lines or information lines in the products. It can be considered that most of all components are actually interconnected.

This invention can be applied to a system that handles fragmentary data, such as an SMS and an SNS.

What is claimed is:

1. A computer comprising;
a processor; and
a memory for storing a program to be executed by the processor,
the memory including a data collection storage area,
the data collection storage area including a plurality of messages created as information on at least one theme, each of the plurality of messages not indicating that the message is about one of the at least one theme,
wherein the computer is configured to include:
a unit creation module for reorganizing the plurality of messages stored in the data collection storage area into at least one data unit including at least one of the plurality of messages to indicate that each of the at least one data unit is about one of the at least one theme;
an index creation module for creating an index from the plurality of messages included in the at least one reorganized data unit;
a search execution module for identifying a data unit matching a search condition based on the created index and the search condition upon receipt of the search condition to search the plurality of messages; and
a result output module for outputting a search result based on the identified data unit.

2. The computer according to claim 1,
wherein the computer is configured to further include an information extraction module for extracting creation times of the plurality of messages included in the data collection storage area and for storing bibliographic information including the extracted creation times to the memory, and
wherein the unit creation module is configured to reorganize the plurality of messages into the at least one data unit based on distribution density of the plurality of creation times included in the bibliographic information.

3. The computer according to claim 2, wherein the unit creation module is configured to;
calculate a difference between a creation time and a latest creation time before the creation time for each of the creation times included in the bibliographic information;
calculate an average of the calculated differences;
determine that two creation times between which the calculated difference is larger them the calculated average are sparse; and
reorganize the plurality of messages into at least two data units in accordance with the two creation times.

4. The computer according to claim 3, wherein the unit creation module is configured to:
acquire a minimum number for messages to be included in a data unit; and
include first messages included in a reorganized first data unit into a second data unit including a second message created last before the first messages and a third data unit including a third message created next to the first messages in a case where a number of the first messages Is less than the minimum number.

5. The computer according to claim 4,
wherein the information extraction module is configured to:
extract sender addresses of the plurality of messages included in the data collection storage area and recipient addresses of the plurality of messages included in the data collection storage area; and
store the extracted sender addresses and the recipient addresses as the bibliographic information, and
wherein the unit creation module is configured to reorganize the plurality of messages into the at least one data unit based on the creation times, the sender addresses, and the recipient addresses.

6. The computer according to claim 5, further comprising an input/output device,
wherein the input/output device displays an interface for receiving the minimum number.

7. A data processing method in a computer including a processor and a memory for storing a program to be executed by the processor,
the memory including a data collection storage area,
the data collection storage area Including a plurality of messages created as information on at least one theme, each of the plurality of messages not indicating that the message is about one of the at least one theme,
the method comprising:
a unit, creation step of reorganizing, by the processor, the plurality of messages stored in the data collection storage area into at least one data unit including at least one of the plurality of messages to indicate that each of the at least one data unit is about one of the at least one theme;
an index creation step of creating, by the processor, an index from the plurality of messages included in the at least one reorganized data unit;
a search execution step of identifying, by the processor, a data unit matching a search condition based on the created index and the search condition upon receipt of the search condition to search the plurality of messages; and
a result output step of outputting, by the processor, a search result based on the Identified data unit.

8. The data processing method according to claim 7, further comprising an information extraction step of extracting, by the processor, creation times of the plurality of messages included in the data collection storage area and storing, by the processor, bibliographic information including the extracted creation times to the memory,
wherein the unit creation step Includes a step of reorganizing, by the processor, the plurality of messages into the at least one data unit based on distribution density of the plurality of creation times included in the bibliographic information.

9. The data processing method according to claim 8, wherein the unit creation step includes:
a step of calculating, by the processor, a difference between a creation time and a latest creation time before the creation time for each of the creation times included in the bibliographic information;
a step of calculating, by the processor, an average of the calculated differences;
a step of determining, by the processor, that two creation times between which the calculated difference Is larger than the calculated average are sparse; and
a step of reorganizing, by the processor, the plurality of messages into at least two data, units in accordance with the two creation times.

10. The data processing method according to claim 9, wherein the unit creation step includes:
a step of acquiring, by the processor, a minimum number for messages to be included in a data unit; and
a step of including, by the processor, first messages included in a reorganized first data unit into a second data unit including a second message created last before the first messages and a third data unit including a third message created next to the first messages in a case where a number of the first messages is less than the minimum number.

11. The data processing method according to claim 10,
wherein the information extraction step includes:
a step of extracting, by the processor, sender addresses of the plurality of messages included in the data collection storage area and recipient addresses of the plurality of messages included In the data collection storage area; and
a step of storing, by the processor, the extracted sender addresses and the recipient addresses as the bibliographic information, and
wherein the unit creation step includes a step of reorganizing, by the processor, the plurality of messages info the at least one data unit based on the creation times, the sender addresses, and the recipient addresses.

12. The data processing method according to claim 11,
wherein the computer further includes an input/output device, and
wherein the method further comprises a step of displaying, by the input/output device, an interface for receiving the minimum number.

13. A non-transitory storage medium readable by a computer,
the computer including a memory including a data collection storage area,
the data collection storage area including a plurality of messages created as information on at least one theme, each of the plurality of messages not indicating that the message is about one of the at least one theme,
the non-transitory storage medium storing a program causing the computer to execute:
a unit creation step of reorganizing the plurality of messages stored in the data collection storage area into at least one data unit including at least one of the plurality of messages to indicate that each of the at least one data unit is about one of the at least one theme;
an index creation step of creating an index from the plurality of messages included in the at least one reorganized data unit;
a search execution step of identifying a data unit matching a search condition based on the created index and the search condition upon receipt of the search condition to search the plurality of messages; and
a result output step of outputting a search result based on the identified data unit.

14. The non-transitory storage medium according to claim 13, wherein the program stored in the non-transitory storage medium causes the computer to execute:
an information extraction step of extracting creation times of the plurality of messages included in the data collection storage area and storing bibliographic information including the extracted creation times to the memory, and
the unit creation step including a step of reorganizing the plurality of messages into the at least one data unit based on distribution density of the plurality of creation times included in the bibliographic information.

15. The non-transitory storage medium according to claim 14, wherein the program stored in the non-transitory storage medium causes the computer to execute the unit creation step including:
a step of calculating a difference between a creation time and a latest creation time before the creation time for each of the creation times included in the bibliographic information;
a step of calculating an average of the calculated differences;
a step of determining that two creation times between which the calculated difference is larger than the calculated average are sparse; and
a step of reorganizing the plurality of messages into at least two data units in accordance with the sparse creation times.
